(19) United States
(12) Patent Application Publication
(10) Pub. No.: US 2008/0231793 A1
(43) Pub. Date: Sep. 25, 2008

(54) Methods for Manufacturing Polarizers, Polarizing Plates and Laminated Optical Films, and Polarizers, Polarizing Plates, Laminated Optical Films, and Image Displays

(75) Inventors: Kazunori Futamura, Osaka (JP); Minoru Miyatake, Osaka (JP); Masahiro Yoshioka, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Nitto Denko Corporation, Osaka (JP)

(21) Appl. No.: 10/592,064

(22) PCT Filed: Mar. 4, 2005
(86) PCT No.: PCT/JP05/03763

§ 371 Date: Sep. 7, 2006

(30) Foreign Application Priority Data
Mar. 8, 2004 (JP) 2004-064288

(51) Int. Cl. B29D 7/01; G02B 1/08; G02B 5/30; G02F 1/13

(52) U.S. Cl. 349/194; 430/20; 264/1.34

(57) ABSTRACT

A method for manufacturing a polarizer of the invention, wherein the polarizer comprises a film that comprises: a matrix made of an optically-transparent resin containing a dichroic absorbing material; and minute domains that are made of an energy ray-curable birefringent material having liquid crystalline properties and are aligned and dispersed in the matrix; and comprising a process of applying energy rays for fixing the alignment of the birefringent material having liquid crystalline properties. A polarizer obtained by the method has a high transmittance and a high polarization degree, and being able to control unevenness of the transmittance in the case of black viewing.

### TECHNICAL FIELD

The invention relates to a method for manufacturing a polarizer. The invention also relates to a method for manufacturing a polarizing plate. The invention also relates to a method for manufacturing a laminated optical film comprising a laminate of a polarizer or a polarizing plate and an optical film such as a retardation plate, a viewing angle compensating film, and a brightness enhancement film. Furthermore, this invention relates to an image display, such as a liquid crystal display, an organic electroluminescence display, a CRT and a PDP using the polarizer, the polarizing plate or the optical film concerned.

### BACKGROUND ART

Liquid crystal display are rapidly developing in market, such as in clocks and watches, cellular phones, PDAs, notebook-sized personal computers, and monitor for personal computers, DVD players, TVs, etc. In the liquid crystal display, visualization is realized based on a variation of polarization state by switching of a liquid crystal, where polarizers are used based on a display principle thereof. Particularly, usage for TV etc. increasingly requires display with high luminance and high contrast, polarizers having higher brightness (high transmittance) and higher contrast (high polarization degree) are being developed and introduced.

As polarizers, for example, since it has a high transmittance and a high polarization degree, polyvinyl alcohols having a structure in which iodine is absorbed and then stretched, that is, iodine based polarizers are widely used (for example, Japanese Patent Application Laid-Open JP-A No. 2001-296427). However, since the iodine based polarizers have relatively low polarization degrees in short wavelength side, they have problems in hue, such as blue omission in black viewing, and yellowing in white viewing, in short wavelength side.

Iodine based polarizers may easily give unevenness in a process of iodine absorption. Accordingly, there has been a problem that the unevenness is detected as unevenness in transmittance particularly in the case of black viewing, causing to decrease of visibility. For example, as methods for solving the problems, several methods have been proposed that an amount of absorption of iodine absorbed to the iodine based polarizer is increased and thereby a transmittance in the case of black viewing is set not higher than sensing limitations of human eyes, and that stretching processes generating little unevenness itself are adopted. However, the former method has a problem that it decreases a transmittance in the case of white viewing, while decreasing a transmittance of black viewing, and as a result darkens the display itself. And also, the latter method has a problem that it requires replacing a process itself, worsening productivity.

On the other hand, there is used a dye-type polarizer including a dichroic dye instead of the iodine compound (for example, Japanese Patent Application Laid-Open JP-A No. 62-123405). However, the absorption dichroic ratio of such a dichroic dye is lower than that of the iodine compound, and thus the characteristics of such a dye-type polarizer are slightly inferior to those of the iodine type polarizers. When a dye is adsorbed, uneven dyeing or uneven dispersion state can easily occur, so that particularly on a liquid crystal display, black viewing can be displayed in an uneven pattern, which can cause the problem of a significant reduction in visibility.

To resolve this problem, there is proposed a dye-type polarizer in which the amount of an adsorbed or added dye is increased such that the transmittance for black viewing does not exceed the lower limit of sensitivity of human eyes. However, such a dye-type polarizer has a decreased transmittance for white viewing as well as that for black viewing so that display itself becomes dark. There is also proposed a method for manufacturing a dye-type polarizer that employs a stretching process, which causes less unevenness (for example, Japanese Patent Application Laid-Open JP-A No. 08-190015). However, such a method requires the process to be entirely replaced and thus reduces the productivity.

### DISCLOSURE OF INVENTION

This invention aims at providing a method for manufacturing a polarizer, a method for manufacturing a polarizing plate, and a method for manufacturing a laminated optical film, which have a high transmittance and a high polarization degree, and being able to control unevenness of the transmittance in the case of black viewing.

Besides, this invention aims at providing a polarizer, a polarizing plate and a laminated optical film obtained by the above methods. Furthermore, this invention aims at providing an image display using the polarizer, the polarizing plate, and the laminated optical film concerned.

As a result of examination wholeheartedly performed by the present inventors that the above-mentioned subject should be solved, it was found out that the above-mentioned purpose might be attained using methods shown below, leading to completion of this invention.

That is, this invention relates to a method for manufacturing a polarizer,

wherein the polarizer comprises a film that comprises: a matrix made of an optically-transparent resin containing a dichroic absorbing material; and minute domains that are made of an energy ray-curable birefringent material having liquid crystalline properties and are aligned and dispersed in the matrix; and

comprising a process of applying energy rays for fixing the alignment of the birefringent material having liquid crystalline properties.

The above-mentioned polarizer of this invention has a polarizer formed by an optically-transparent resin and a dichroic absorbing material as a matrix, and has dispersed minute domains in the above-mentioned matrix. Minute domains are preferably formed by oriented materials having birefringence, and particularly minute domains are formed preferably with materials showing liquid crystallinity. Thus, in addition to function of absorption dichroism by dichroic absorbing materials, characteristics of having function of scattering anisotropy improve polarization performance according to synergistic effect of the two functions, and as a result a polarizer having both of transmittance and polarization degree, and excellent visibility may be provided.

Scattering performance of anisotropic scattering originates in refractive index difference between matrixes and minute domains. For example, if materials forming minute domains are liquid crystalline materials, since they have higher wavelength dispersion of Δn compared with optically-transparent resins as a matrix, a refractive index difference in scattering axis becomes larger in shorter wavelength side, and, as a result, it provides more amounts of scattering in shorter wavelength. Accordingly, an improving effect of large polarization performance is realized in shorter wavelengths, compensating a relative low level of polarization performance of an iodine based polarizer in a side of shorter wavelength, and thus a polarizer having high polarization and neutral hue may be realized.

Concerning the above polarizer, there have been filed Japanese Patent Application No. 2003-329744 (iodine type) and Japanese Patent Application No. 2003-312239 (dye type). In the above polarizer, although the matrix part of the film is aligned (stretched) so that stress is applied to the minute domain-forming liquid crystalline material to align it in the direction of the stretching axis, the stress applied to the liquid crystalline material varies with the type of the matrix or the liquid crystalline material and the stretching conditions such as the stretching temperature and the stretching speed so that it is difficult to completely align the liquid crystalline material only by stretching or the like. In a part where the liquid crystalline material is incompletely aligned, the material is allowed to have an isotropic state so that the effect of anisotropic scattering can fail to occur and that depolarization can also occur to degrade the properties of the polarizer.

According to the invention, therefore, the process of applying energy rays is provided in order to further improve the alignment of an energy ray-curable liquid crystalline material used for the minute domains in the polarizer. If the liquid crystalline material is a liquid crystalline thermoplastic resin, the material can be aligned by stretching and then the alignment can be fixed and stabilized by cooling to room temperature. If aligned, the liquid crystalline material can exhibit the desired optical properties and thus does not always have to be cured. However, if the energy ray-curable liquid crystalline material has a relatively low isotropic transition temperature, it can be made isotropic by the application of a small amount of heat, so that anisotropic scattering can be cancelled and that the polarization performance can be adversely degraded. In such a case, the material should preferably be cured. Many energy ray-curable liquid crystalline materials can be crystallized by allowing them to stand at room temperature. Also in such cases, anisotropic scattering can be cancelled and the polarization performance can be adversely degraded, and thus the materials should preferably be cured. Under the circumstances, in order to ensure stable existence of the alignment state under any conditions, the liquid crystalline material should preferably be cured.

As the above method for manufacturing the polarizer, it is exemplified a method comprises the processes of:

(1) preparing a mixture solution that includes the optically-transparent resin and the birefringent material having liquid crystalline properties that is dispersed in the resin;

(2) forming the mixture solution of the process (1) into a film;

(3) orienting the film obtained in the process (2);

(4) dispersing the dichroic absorbing material into the optically-transparent resin for forming the matrix; and

(5) applying the energy rays.

In the above method for manufacturing the polarizer, the mixture solution can contain a photopolymerization initiator.

This invention also relates to a polarizer obtained by the above method.

This invention also relates to a polarizer, comprising:

a film that comprises: a matrix made of an optically-transparent resin containing a dichroic absorbing material; and minute domains that are made of an energy ray-curable birefringent material having liquid crystalline properties and are aligned and dispersed in the matrix; and a photopolymerization initiator.

This invention also relates to a polarizing plate, comprising: the above polarizer; and a transparent protective layer provided on at least one side of the polarizer. Further this invention relates to an optical film, comprising at least one laminated piece of the above polarizer.

This invention relates to a method for manufacturing a polarizing plate, comprising adhering a transparent protective layer through an adhesive to the polarizer:

wherein the polarizer comprises a film that comprises: a matrix made of an optically-transparent resin containing a dichroic absorbing material; and minute domains that are made of an energy ray-curable birefringent material having liquid crystalline properties and are aligned and dispersed in the matrix; and

comprising a process of applying energy rays for fixing the alignment of the birefringent material having liquid crystalline properties after the adhering.

When manufacturing the above polarizing plate to adhere a transparent protective layer through an adhesive to the polarizer of the invention, a polarizing plate having improved alignment is obtained to apply energy rays after the adhering.

This invention also relates to a polarizing plate obtained by the above method. Further this invention also relates to an optical film, comprising at least one laminated piece of the above polarizing plate.

This invention also relates to a method for manufacturing a laminated optical film, comprising: adhering an optical film through an adhesive or a pressure-sensitive adhesive to a polarizer or a polarizing plate comprising a polarizer and a transparent protective layer provided on at least one side of the polarizer;

wherein the polarizer comprises a film that comprises: a matrix made of an optically-transparent resin containing a dichroic absorbing material; and minute domains that are made of an energy ray-curable birefringent material having liquid crystalline properties and are aligned and dispersed in the matrix;

comprising a process of applying energy rays for fixing the alignment of the birefringent material having liquid crystalline properties after the adhering.

When manufacturing the above laminated optical film to adhere an optical film through an adhesive or a pressure-sensitive adhesive to the above polarizer or a polarizing plate of the invention comprising the above polarizer, a laminated optical film having improved alignment is obtained to apply energy rays after the adhering.

This invention also relates to a laminated optical film obtained by the above method.

Further this invention relates to an image display, comprising the above polarizer, the above polarizing plate, or the above optical film (the laminated optical film).

### (Characteristics of Polarizer)

The above polarizer preferable has a birefringence of the minute domains of 0.02 or more. In materials used for minute domains, in the view point of gaining larger anisotropic scattering function, materials having the above-mentioned birefringence may be preferably used.

In the above-mentioned polarizer, in a refractive index difference between the birefringent material forming the minute domains and the optically-transparent resin in each optical axis direction, a refractive index difference (Δn¹) in direction of axis showing a maximum is 0.03 or more, and a refractive index difference (Δn²) between the Δn¹ direction and a direction of axes of two directions perpendicular to the Δn¹ direction is 50% or less of the Δn¹

Control of the above-mentioned refractive index difference (Δn¹) and (Δn²) in each optical axis direction into the above-mentioned range may provide a scattering anisotropic film having function being able to selectively scatter only linearly polarized light in the Δn¹ direction, as is submitted in U.S. Pat. No. 2,123,902 specification. That is, on one hand, having a large refractive index difference in the Δn¹ direction, it may scatter linearly polarized light, and on the other hand, having a small refractive index difference in the Δn² direction, it may transmit linearly polarized light. Moreover, refractive index differences (Δn²) in the directions of axes of two directions perpendicular to the Δn¹ direction are preferably equal.

In order to obtain high scattering anisotropy, a refractive index difference (Δn¹) in a Δn¹ direction is set 0.03 or more, preferably 0.05 or more, and still preferably 0.10 or more. A refractive index difference (Δn²) in two directions perpendicular to the Δn¹ direction is 50% or less of the above-mentioned Δn¹, and preferably 30% or less.

The dichroic absorbing material in the above polarizer, an absorption axis of the material concerned preferably is orientated in the Δn¹ direction.

The dichroic absorbing material in a matrix is orientated so that an absorption axis of the material may become parallel to the above-mentioned Δn¹ direction, and thereby linearly polarized light in the Δn¹ direction as a scattering polarizing direction may be selectively absorbed. As a result, on one hand, a linearly polarized light component of incident light in a Δn² direction is not scattered or hardly absorbed by the conventional absorbing material as in conventional polarizers without anisotropic scattering performance. On the other hand, a linearly polarized light component in the Δn¹ direction is scattered, and is absorbed by the dichroic absorbing material. Usually, absorption is determined by an absorption coefficient and a thickness. In such a case, scattering of light greatly lengthens an optical path length compared with a case where scattering is not given. As a result, polarized component in the Δn¹ direction is more absorbed as compared with a case in conventional polarizers. That is, higher polarization degrees may be attained with same transmittances.

Descriptions for ideal models will, hereinafter, be given. Two main transmittances usually used for linear polarizer (a first main transmittance k₁ (a maximum transmission direction=linearly polarized light transmittance in a Δn² direction), a second main transmittance k₂ (a minimum transmission direction=linearly polarized light transmittance in a Δn¹ direction)) are, hereinafter, used to give discussion.

In commercially available iodine based polarizers, when the dichroic absorbing materials (iodine based light absorbing materials) are oriented in one direction, a parallel transmittance and a polarization degree may be represented as follows, respectively:

parallel transmittance=0.5×((k₁)²+(k₂)²) and

polarization degree=(k₁−k₂)/(k₁+k₂).

On the other hand, when it is assumed that, in a polarizer of this invention, a polarized light in a Δn¹ direction is scattered and an average optical path length is increased by a factor of α(>1), and depolarization by scattering may be ignored, main transmittances in this case may be represented as k₁ and k₂′=10^{x} (where, x is α log k₂), respectively

That is, a parallel transmittance in this case and the polarization degree are represented as follows:

parallel transmittance=0.5×((k₁)²+(k₂′)²) and

polarization degree=(k₁−k₂′)/(k₁+k₂′).

When a polarizer of this invention is prepared by a same condition (an amount of dyeing and production procedure are same) as in commercially available iodine based polarizers (parallel transmittance 0.385, polarization degree 0.965: k₁=0.877, k₂=0.016), on calculation, when α is 2 times, k₂ becomes small reaching 0.0003, and as result, a polarization degree improves up to 0.999, while a parallel transmittance is maintained as 0.385. The above-mentioned result is on calculation, and function may decrease a little by effect of depolarization caused by scattering, surface reflection, backscattering, etc. As the above-mentioned equations show, higher value α may give better results and higher dichroic ratio of the dichroic absorbing material may provide higher function. In order to obtain higher value α, a highest possible scattering anisotropy function may be realized and polarized light in a Δn¹ direction may just be selectively and strongly scattered. Besides, less backscattering is preferable, and a ratio of backscattering strength to incident light strength is preferably 30% or less, and more preferably 20% or less.

The minute domains of the above-mentioned polarizer preferably have a length in a Δn² direction of 0.05 to 500 μm.

In order to scatter strongly linearly polarized light having a plane of vibration in a Δn¹ direction in wavelengths of visible light band, dispersed minute domains have a length controlled to 0.05 to 500 μm in a Δn² direction, and preferably controlled to 0.5 to 100 μm. When the length in the Δn² direction of the minute domains is too short a compared with wavelengths, scattering may not fully provided. On the other hand, when the length in the Δn² direction of the minute domains is too long, there is a possibility that a problem of decrease in film strength or of liquid crystalline material forming minute domains not fully oriented in the minute domains may arise.

As the dichroic absorbing material, the iodine based light absorbing materials or the absorption dichroic dyes or etc. are used. In a case of the polarizer (iodine type), a transmittance to a linearly polarized light in a transmission direction is 80% or more, a haze value is 5% or less, and a haze value to a linearly polarized light in an absorption direction is 30% or more. In a case of the polarizer (dye-type), a transmittance to a linearly polarized light in a transmission direction is 80% or more, a haze value is 10% or less, and a haze value to a linearly polarized light in an absorption direction is 50% or more.

A polarizer of this invention having the above-mentioned transmittance and haze value has a high transmittance and excellent visibility for linearly polarized light in a transmission direction, and has strong optical diffusibility for linearly polarized light in an absorption direction. Therefore, without sacrificing other optical properties and using a simple method, it may demonstrate a high transmittance and a high polarization degree, and may control unevenness of the transmittance in the case of black viewing.

As a polarizer of this invention, a polarizer is preferable that has as high as possible transmittance to linearly polarized light in a transmission direction, that is, linearly polarized light in a direction perpendicular to a direction of maximal absorption of the above dichroic absorbing material, and that has 80% or more of light transmittance when an optical intensity of incident linearly polarized light is set to 100. The light transmittance is preferably 85% or more, and still preferably 88% or more. Here, a light transmittance is equivalent to a value Y calculated from a spectral transmittance in 380 nm to 780 nm measured using a spectrophotometer with an integrating sphere based on CIE 1931 XYZ standard colorimetric system. In addition, since about 8% to 10% is reflected by an air interface on a front surface and rear surface of a polarizer, an ideal limit is a value in which a part for this surface reflection is deducted from 100%.

It is desirable that the polarizer (iodine type) does not scatter linearly polarized light in a transmission direction in the view point of obtaining clear visibility of a display image. Accordingly, the polarizer preferably has 5% or less of haze value to the linearly polarized light in the transmission direction, more preferably 3% or less, and still more preferably 1% or less. On the other hand, in the view point of covering unevenness by a local transmittance variation by scattering, a polarizer desirably scatters strongly linearly polarized light in an absorption direction, that is, linearly polarized light in a direction for a maximal absorption of the above-mentioned iodine based light absorbing material. Accordingly, a haze value to the linearly polarized light in the absorption direction is preferably 30% or more, more preferably 40% or more, and still more preferably 50% or more. In addition, the haze value here is measured based on JIS K 7136 (how to obtain a haze of plastics-transparent material).

It is desirable that the polarizer (dye-type) does not scatter linearly polarized light in a transmission direction in the view point of obtaining clear visibility of a display image. Accordingly, the polarizer preferably has 10% or less of haze value to the linearly polarized light in the transmission direction, more preferably 5% or less, and still more preferably 3% or less. On the other hand, in the view point of covering unevenness by a local transmittance variation by scattering, a polarizer desirably scatters strongly linearly polarized light in an absorption direction, that is, linearly polarized light in a direction for a maximal absorption of the above-mentioned absorption dichroic dyes. Accordingly, a haze value to the linearly polarized light in the absorption direction is preferably 50% or more, more preferably 60% or more, and still more preferably 70% or more. In addition, the haze value here is measured based on JIS K 7136 (how to obtain a haze of plastics-transparent material).

The above-mentioned optical properties are obtained by compounding a function of scattering anisotropy with a function of an absorption dichroism of the polarizer. As is indicated in U.S. Pat. No. 2,123,902 specification, Japanese Patent Application Laid-Open JP-A No. 9-274108, and Japanese Patent Application Laid-Open JP-A No. 9-297204, same characteristics may probably be attained also in a way that a scattering anisotropic film having a function to selectively scatter only linearly polarized light, and a dichroism absorption type polarizer are superimposed in an axial arrangement so that an axis providing a greatest scattering and an axis providing a greatest absorption may be parallel to each other. These methods, however, require necessity for separate formation of a scattering anisotropic film, have a problem of precision in axial joint in case of superposition, and furthermore, a simple superposition method does not provide increase in effect of the above-mentioned optical path length of the polarized light absorbed as is expected, and as a result, the method cannot easily attain a high transmission and a high polarization degree.

### BRIEF DESCRIPTION OF DRAWING

FIG. 1 is conceptual top view showing an example of a polarizer of this invention;

FIG. 2 is graphs showing polarized light absorption spectra of polarizers in Example 1 and Comparative example 1; and

### BEST MODE FOR CARRYING OUT THE INVENTION

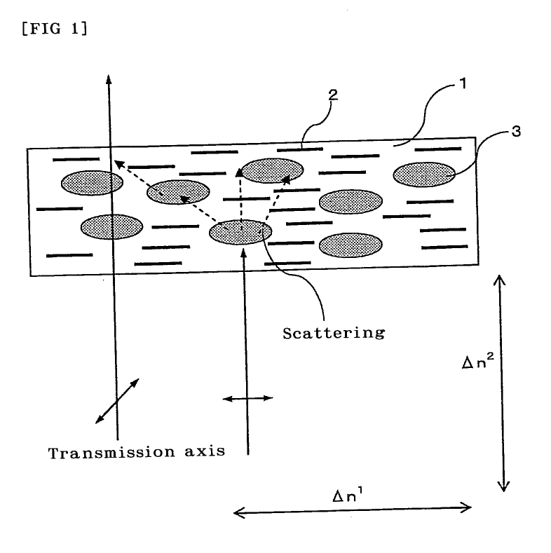

The polarizer of the invention is first described with reference to the drawings. FIG. 1 is a schematic diagram showing the polarizer of the invention which has a structure including: a matrix of a film made of an optically-transparent resin 1 containing a dichroic absorbing material 2; and minute domains 3 dispersed in the matrix. While in the polarizer of the invention, the dichroic absorbing material 2 significantly exists in the optically-transparent resin 1 that forms the film serving as the matrix, the dichroic absorbing material 2 may also exist in the minute domains 3 at such a level that it cannot have an optical effect.

FIG. 1 shows an example of a case where the dichroic absorbing material 2 is oriented in a direction of axis (Δn¹ direction) in which a refractive index difference between the minute domain 3 and the optically-transparent resin 1 shows a maximal value. In minute domain 3, a polarized component in the Δn¹ direction are scattered. In FIG. 1, the Δn¹ direction in one direction in a film plane is an absorption axis. In the film plane, a Δn² direction perpendicular to the Δn¹ direction serves as a transmission axis. Another Δn² direction perpendicular to the Δn¹ direction is a thickness direction.

As the optically-transparent resins 1, resins having transparency in a visible light band and dispersing and absorbing the dichroic absorbing materials may be used without particular limitation. For example, polyvinyl alcohols or derivatives thereof conventionally used for polarizers may be mentioned. As derivatives of polyvinyl alcohol, polyvinyl formals, polyvinyl acetals, etc. may be mentioned, and in addition derivatives modified with olefins, such as ethylene and propylene, and unsaturated carboxylic acids, such as acrylic acid, methacrylic acid, and crotonic acid, alkyl esters of unsaturated carboxylic acids, acrylamides etc. may be mentioned. Besides, as optically-transparent resin 1, for example, polyvinyl pyrrolidone based resins, amylose based resins, etc. may be mentioned. The above-mentioned optically-transparent resin may be of resins having isotropy not easily generating orientation birefringence caused by molding deformation etc., and of resins having anisotropy easily generating orientation birefringence.

As the optically-transparent resins 1, for example, polyester type resins, such as polyethylene terephthalate and polyethylenenaphthalate; styrene type polymers, such as polystyrene and acrylonitrile-styrene copolymer (AS resin); polyolefin type resin, such as polyethylene, polypropylene, polyolefin that has cyclo-type or norbornene structure, ethylene-propylene copolymer; may be mentioned. Besides, vinyl chloride type resins; cellulose type resins; acrylics type resins; amide type resins; imide type resins; sulfone type polymers; polyether sulfone type polymers; polyether-ether ketone type polymers; poly phenylene sulfide type resins; vinyl alcohol type resins; vinylidene chloride type resins; vinyl butyral type polymers; arylate type resins; polyoxymethylene type resins; silicone type resinss; urethane type resins may be mentioned. These resins are use as one kind or two or more kinds combined. And heat curing type or ultraviolet ray curing type resins, such as phenol based, melamine based, acryl based, urethane based, acryl urethane based, epoxy based, and silicone based, etc. may be mentioned.

The material for forming the minute domains 3 to be used is an energy ray-curable birefringent material having liquid crystalline properties. The liquid crystalline material may be nematic, smectic or cholesteric or may be lyotropic. After formulated, the liquid crystalline material is fixed by polymerization, crosslinking or the like with energy rays to form the minute domains 3.

The liquid crystalline material for forming the minute domains 3 may have a mesogenic group and a polymerizable functional group. As the above-mentioned cyclic units used as mesogen groups, biphenyl based, phenyl benzoate based, phenylcyclohexane based, azoxybenzene based, azomethine based, azobenzene based, phenyl pyrimidine based, diphenyl acetylene based, diphenyl benzoate based, bicyclo hexane based, cyclohexylbenzene based, terphenyl based units, etc. may be mentioned. Terminal groups of these cyclic units may have substituents, such as cyano group, alkyl group, alkenyl group, alkoxy group, halogen group, haloalkyl group, haloalkoxy group, and haloalkenyl group. Groups having halogen groups may be used for phenyl groups of mesogen groups.

Besides, any mesogen groups of the liquid crystal polymer may be bonded via a spacer part giving flexibility. As spacer parts, polymethylene chain, polyoxymethylene chain, etc. may be mentioned. A number of repetitions of structural units forming the spacer parts is suitably determined by chemical structure of mesogen parts, and the number of repeating units of polymethylene chain is 0 to 20, preferably 2 to 12, and the number of repeating units of polyoxymethylene chain is 0 to 10, and preferably 1 to 3.

As polymerizable functional groups, acryloyl groups and methacryloyl groups etc. may be mentioned. Crossed-linked structures may be introduced using polymerizable functional groups having two or more acryloyl groups, methacryloyl groups, etc., and durability may also be improved.

Examples of the dichroic absorbing material 2 include iodine based light-absorbing materials and absorption dichroic dyes and pigments. The iodine based light-absorbing material is particularly preferred in terms of high polarization degree and high transmittance, in cases where an optically-transparent resin such as polyvinyl alcohol is used as the optically-transparent resin 1 for the matrix material.

Iodine based light absorbing material means chemical species comprising iodine and absorbs visible light, and it is thought that, in general, they are formed by interaction between optically-transparent resins (particularly polyvinyl alcohol based resins) and poly iodine ions (I₃_{^{−}}, I₅_{^{−}}, etc.). An iodine based light absorbing material is also called an iodine complex. It is thought that poly iodine ions are generated from iodine and iodide ions.

In the above-mentioned polarizer, iodine light absorbing materials having an absorption band at least in a wavelength range of 400 to 700 nm may be used.

As the absorption dichroic dye, preferably used is a dye that does not lose a dichroic performance due to decomposition or degeneration even in a case where a liquid crystalline material having heat resistance and birefringence is heated and aligned. The absorption dichroic dye is, as described above, preferably a dye having at least one absorption band with a dichroic ratio of 3 or more in the visible light wavelength region. Used as a measure evaluating a dichroic ratio is, for example, an absorption dichroic ratio at the absorption maximum wavelength in a polarization absorption spectrum measured using a liquid crystal cell in homogenous alignment prepared using a proper liquid crystal material in which a dye is dissolved. In the evaluation method, a dye used, for example, in a case where E-7 manufactured by Merck Co. is used as a standard liquid crystal, preferably has a dichroic ratio at the absorption wavelength of, usually, 3 or more, preferably 6 or more and more preferably 9 or more as an aim value.

Examples of such dyes with a high dichroic ratio include: an azo-based dye, a perylene-based dye and an anthraquinone-based dye which are preferably used in a dye-based polarizer. The dyes can be used as a mixed type dye. The dyes are detailed in JP-A No. 54-76171 or the like.

In a case where a color polarizer is produced, there can be used a dye having an absorption wavelength matching a characteristic thereof. In a case where a neutral gray polarizer is produced, two or more kinds of dyes are properly mixed together so as cause absorption across all of the visible light region.

In a polarizer of this invention, while producing a film in which a matrix is formed with a optically-transparent resin 1 including an dichroic absorbing material 2, minute domains 3 (for example, an oriented birefringent material formed with liquid crystalline materials) are dispersed in the matrix concerned.

Moreover, the above-mentioned refractive index difference (Δn¹) in a Δn¹ direction and a refractive index difference (Δn²) in a Δn² direction are controlled to be in the above-mentioned range in the film.

Any manufacturing processes may be used to prepare the polarizer of the invention as long as it can produce the above-described polarizer and includes the process (5) of applying energy rays for fixing the alignment of the energy ray-curable birefringent material having liquid crystalline properties. Examples of processes other than the energy ray applying process (5) include: the process (1) of preparing a mixture solution that includes an optically-transparent resin for forming a matrix and a liquid crystalline material for forming minute domains dispersed in the resin,

the process (2) of forming the mixture solution of the process (1) into a film,
the process (3) of stretching (orienting) the film obtained in the process (2), and
the process (4) of dispersing (dyeing) a dichroic absorbing material into the optically-transparent resin for forming the matrix. The order in which the processes (1) to (5) are performed may be appropriately determined.

In the above-mentioned process (1), a mixed solution is firstly prepared in which a liquid crystalline material forming minute domains is dispersed in a optically-transparent resin forming a matrix. A method for preparing the mixed solution concerned is not especially limited, and a method may be mentioned of utilizing a phase separation phenomenon between the above-mentioned matrix component (an optically-transparent resin) and a liquid crystalline material (monomer). For example, a method may be mentioned in which a material having poor compatibility between the matrix component as a liquid crystalline material is selected, a solution of the material forming the liquid crystalline material is dispersed using dispersing agents, such as a surface active agent, in a water solution of the matrix component. In preparation of the above-mentioned mixed solution, some of combinations of the optically-transparent material forming the matrix, and the liquid crystal material forming minute domains do not require a dispersing agent. An amount used of the liquid crystalline material dispersed in the matrix is not especially limited, and a liquid crystalline material is 0.01 to 100 parts by weight to an optically-transparent resin 100 parts by weight, and preferably it is 0.1 to 10 parts by weight. The liquid crystalline material is used in a state dissolved or not dissolved in a solvent. Examples of solvents, for example, include: water, toluene, xylene, hexane cyclohexane, dichloromethane, trichloromethane, dichloroethane, trichloroethane, tetrachloroethane, trichloroethylene, methyl ethyl ketone, methylisobutylketone, cyclohexanone, cyclopentanone, tetrahydrofuran, ethyl acetate, etc. Solvents for the matrix components and solvents for the liquid crystalline materials may be of same, or may be of different solvents.

In the preparation of the mixture solution, a photopolymerization initiator may be added, if ultraviolet rays are used as the energy rays in the energy ray applying process (5). Any type of photopolymerization initiator may be used without particular limitation. Examples of the photopolymerization initiator include Irgacure 184, Irgacure 907, Irgacure 369, Irgacure 651, and the like manufactured by Ciba Specialty Chemicals Inc. The amount of the blended photopolymerization initiator is preferably at most 10 parts by weight, more preferably from about 0.01 to 10 parts by weight, still more preferably from 0.05 to 5 parts by weight, based on 100 parts by weight of the liquid crystalline material. If the energy ray applying process (5) uses radiation rays with energy higher than that of ultraviolet rays, such as electron beams, X-rays and gamma rays as the energy rays, the photopolymerization initiator may not be used or may be added in a small amount in order to reduce the necessary radiation quantity for curing. The absence of the photopolymerization initiator is preferred, because it can lead to an improvement in the alignment of the liquid crystalline material or a reduction in material cost.

If ultraviolet rays are used as the energy rays in the energy ray applying process (5), a photo-sensitizer may be added. The photo-sensitizer may be of a benzoin type, an acetophenone type, a benzyl ketal type, or the like. Examples of the photo-sensitizer include acetophenone, benzophenone, 4-methoxybenzophenone, benzoin methyl ether, 2,2-dimethoxy-2-phenyldimethoxy-2-phenylacetophenone, benzyl, benzoyl, 2-methylbenzoin, 2-hydroxy-2-methyl-1-phenyl-1-one, 1-(4-isopropylphenyl)-2-hydroxy-2-methylpropane-1-one, triphenylphosphine, and 2-chlorothioxanthone. The amount of the added photo-sensitizer may be the same as that of the photopolymerization initiator. If the energy ray applying process (5) uses radiation rays with energy higher than that of ultraviolet rays, such as electron beams, X-rays and gamma rays as the energy rays, the photo-sensitizer may not be used or may be added in a small amount in order to reduce the necessary radiation quantity for curing. The absence of both the photopolymerization initiator and the photo-sensitizer is preferred, because it can lead to an improvement in the alignment of the liquid crystalline material or a reduction in material cost.

A polymerization inhibitor may also be added. If the polymerization initiator is added, polymerization can be initiated in some cases by the heat during the process of forming and drying films. In such cases, a polymerization inhibitor is preferably added for appropriate control. Various types of polymerization inhibitors may be used without particular limitation. Examples thereof include hydroquinone monomethyl ether, hydroquinone, methoquinone, p-benzoquinone, phenothiazine, mono-tert-butylhydroquinone, catechol, p-tert-butylcatechol, benzoquinone, 2,5-di-tert-butylhydroquinone, anthraquinone, 2,6-di-tert-butylhydroxytoluene, and tert-butylcatechol. Any of these materials may be used, as long as a similar effect can be produced. The amount of the added polymerization inhibitor may be the same as that of the added photopolymerization initiator.

In the above-mentioned process (2), in order to reduce foaming in a drying process after a film formation, it is desirable that solvents for dissolving the liquid crystalline material forming minute domains is not used in preparation of the mixed solution in the process (1). When solvents are not used, for example, a method may be mentioned in which a liquid crystalline material is directly added to an aqueous solution of a translucency material forming a matrix, and then is heated above a liquid crystal temperature range in order to disperse the liquid crystalline material uniformly in a smaller state.

In addition, a solution of a matrix component, a solution of a liquid crystalline material, or a mixed solution may include various kinds of additives, such as dispersing agents, surface active agents, ultraviolet absorption agents, flame retardants, antioxidants, plasticizers, mold lubricants, other lubricants, and colorants in a range not disturbing an object of this invention.

In the process (2) for obtaining a film of the above-mentioned mixed solution, the above-mentioned mixed solution is heated and dried to remove solvents, and thus a film with minute domains dispersed in the matrix is produced. As methods for formation of the film, various kinds of methods, such as casting methods, extrusion methods, injection molding methods, roll molding methods, and flow casting molding methods, may be adopted. In film molding, a size of minute domains in the film is controlled to be in a range of 0.05 to 500 μm in a Δn² direction. Sizes and dispersibility of the minute domains may be controlled, by adjusting a viscosity of the mixed solution, selection and combination of the solvent of the mixed solution, dispersant, and thermal processes (cooling rate) of the mixed solvent and a rate of drying. For example, a mixed solution of a optically-transparent resin that has a high viscosity and generates high shearing force and that forms a matrix, and a liquid crystalline material forming minute domains is dispersed by agitators, such as a homogeneous mixer, being heated at a temperature in no less than a range of a liquid crystal temperature, and thereby minute domains may be dispersed in a smaller state.

The process (3) giving orientation to the above-mentioned film may be performed by stretching the film. In stretching, uniaxial stretching, biaxial stretching, diagonal stretching are exemplified, but uniaxial stretching is usually performed. Any of dry type stretching in air and wet type stretching in an aqueous system bath may be adopted as the stretching method. If wet type stretching is used, the water-based bath may contain any appropriate additive (such as a boron compound including boric acid and an alkali metal iodide in the case that iodine is used as the dichroic absorbing material 2). In the case of the dye type, dry type stretching is also preferably used. While the stretching may be performed at any stretch ratio, it is preferably performed at a stretch ratio of about 2 to about 10 times.

This stretching may orient the dichroic absorbing material in a direction of stretching axis. Moreover, the liquid crystalline material forming a birefringent material is oriented in the stretching direction in minute domains by the above-mentioned stretching, and as a result birefringence is demonstrated.

It is desirable the minute domains may be deformed according to stretching. When minute domains are of non-liquid crystalline materials, approximate temperatures of glass transition temperatures of the resins are desirably selected as stretching temperatures, and when the minute domains are of liquid crystalline materials, temperatures making the liquid crystalline materials exist in a liquid crystal state such as nematic phase or smectic phase or an isotropic phase state, are desirably selected as stretching temperatures. When inadequate orientation is given by stretching process, processes, such as heating orientation treatment, may separately be added to improve orientation effectively.

In addition to the stretching, an external field such as an electric field and a magnetic field may be used to align the liquid crystalline material. If the liquid crystalline material is mixed with a photo-reactive substance such as azobenzene or if a photo-reactive group such as a cinnamoyl group is incorporated in the liquid crystalline material for use, the energy ray applying process (5) may also serve as a process of aligning the liquid crystalline material. The stretching process may be used in combination with the alignment process as described above.

The process (4) of dispersing the dichroic absorbing material into the optically-transparent resin for the matrix may generally include a method of dipping the film in a water-based bath comprising a solution of the dichroic absorbing material. The timing of the dipping may be before or after the stretching process (3). When iodine is used as the dichroic absorbing material, an auxiliary agent such as an alkali metal iodide such as potassium iodide is preferably added to the water-based bath. As described above, iodine dispersed in the matrix interacts with the matrix resin to form a dichroic absorbing material. It should be noted that in general, the iodine based light-absorbing material is significantly produced through the stretching process. The concentration of the iodine-containing water-based bath or the content of the auxiliary agent such as an alkali metal iodide may be any value according to general iodine staining methods and may be freely changed.

If iodine is used as the dichroic absorbing material, a percentage of the iodine in the polarizer obtained is not especially limited, but a percentage of the optically-transparent resin and the iodine is preferably controlled to be 0.05 to 50 part(s) by weight grade to the optically-transparent resin 100 parts by weight, and more preferably 0.1 to 10 parts by weight.

If the absorption dichroic dye is used as the dichroic absorbing material, a percentage of the absorption dichroic dye in the polarizer obtained is not especially limited, but a percentage of the optically-transparent resin and the absorption dichroic dye is preferably controlled to be 0.05 to 50 parts by weight grade to the optically-transparent resin 100 parts by weight, and more preferably 0.1 to 10 parts by weight.

In the energy ray applying process (5), the liquid crystalline material that forms the minute domains in the film is cured so that the alignment is fixed. Any energy rays that can cure the liquid crystalline material and fix the alignment may be used. Examples of such energy rays include ultraviolet rays, electron beams, visible light, laser light, infrared rays, heat rays, X-rays, gamma rays, alpha rays, and ultrasonic waves. The energy rays are preferably ultraviolet rays or electron beams. Ultraviolet rays have the advantage that the irradiation equipment is simple and easy to handle. It should be noted that the use of ultraviolet rays may require the use of an initiator in the preparation of the mixture solution, which can increase the material cost. In the presence of any ultraviolet-absorbing material (any dye or protective film in this case), the irradiation time tends to be longer. On the other hand, electron beams have the advantages that the initiator is unnecessary, the process is fast, and materials can be selected regardless of color (consideration of absorption as in the case of ultraviolet rays is unnecessary, and the attenuation simply depends on material thickness.) Since electron beams have high energy, it should be necessary to prevent material degradation (some materials are not degraded or resistant to degradation). Particularly in optical applications, only discoloration is not preferred even without degradation, and thus it should be necessary to prevent degradation or discoloration of materials. As compared with ultraviolet rays, electron beams should need a large amount of nitrogen gas for replacement in the irradiation system. However, electron beams can provide a high treatment speed, and thus there is no significant difference in the treatment speed per unit area between electron beams and ultraviolet rays.

The energy ray exposure dose may be appropriately determined depending on the combination of the liquid crystalline material and the optically-transparent resin for forming the matrix. In a case where a high pressure mercury UV lamp is used for the application of UV energy rays, for example, the exposure dose is from about 1 to about 3000 mJ/cm², preferably from 10 to 1000 mJ/cm². Besides the high pressure mercury UV lamp, any other type of lamp such as a metal halide UV lamp and an incandescent lamp may also be used for ultraviolet irradiation. In a case where electron beams are used as the energy rays, the irradiation dose may be about 1 to about 500 kGy, and preferably from 3 to 300 kGy. Too high irradiation or exposure doses can disintegrate the film or the liquid crystalline material and thus are not preferred. The electron beam irradiation dose can be reduced by simultaneous use of an appropriate initiator. Relatively small doses of energy ray exposure or irradiation are preferred, because such doses have less effect on materials themselves or cost.

The energy rays to be applied may be polarized or unpolarized. Polarized energy rays can fix the alignment of the liquid crystalline material while improving the alignment. For example, such energy rays may be polarized ultraviolet rays. Even with normal ultraviolet rays, the alignment can be improved by controlling the irradiation angle. Alternatively, energy rays such as ultraviolet rays and magnetic field lines may be applied at the same time to improve the alignment.

After the liquid crystalline material is aligned by the stretching process (3), the energy ray applying process (5) may be performed at any timing (before or after dyeing with the dichroic absorbing material). The energy ray applying process (5) is preferably performed after the liquid crystalline material is well aligned such that curing for anisotropic scattering can be sufficiently effected.

The energy rays may be applied to either the upper or lower side of the film or to both sides. In the energy ray applying process (5), a plurality of portions may be irradiated as needed, or irradiation may be performed twice or more. In a case where the liquid crystalline material used can be cured even with normal indoor light, each process is preferably performed under light-shielded conditions for blocking light radiation from curing the liquid crystalline material until the minute domains undergo the alignment treatment in the process (3).

If the energy rays are applied to a dichroic dye-containing polarizer, a dichroic dye that does not absorb the wavelength of the energy rays to be applied should preferably be used. If the dichroic dye absorbs the wavelength of the energy rays to be applied, any appropriate sensitizer should preferably added so as to produce radicals that absorb different wavelengths to cure the aligned liquid crystalline material.

In production of the polarizer, processes (6) for various purposes may be given other than the above-mentioned processes (1) through (5). As a process (6), for example, a process in which a film is immersed in water bath and swollen may be mentioned for the purpose of mainly improving iodine dyeing efficiency of the film. Besides, a process in which a film is immersed in a water bath including arbitrary additives dissolved therein may be mentioned. A process in which a film is immersed in an aqueous solution including additives, such as boric acid and borax, for the purpose of cross-linking a water-soluble resin (matrix) may be mentioned. Moreover, if iodine is used as the dichroic absorbing material, for the purpose of mainly adjusting an amount balance of the dispersed dichroic absorbing material, and adjusting a hue, a process in which a film is immersed to an aqueous solution including additives, such as an iodide of an alkaline metals may be mentioned. If the process (3) uses a wet type stretching process or the like, a drying process may also be provided.

As for the process (3) of orienting (stretching) of the above-mentioned film, the process (4) of dispersing and dyeing the dichroic absorbing material to a matrix resin, the energy ray applying process (5) and the above-mentioned process (6), so long as each of the processes (3), (4) and (5) is provided at least 1 time, respectively, a number, order and conditions (a bath temperature, immersion period of time, etc.) of the processes, may arbitrarily be selected, each process may separately be performed and furthermore a plurality of processes may simultaneously be performed. For example, a cross-linking process of the process (6) and the stretching process (3) may be carried out simultaneously.

In addition, although the dichroic absorbing material used for dyeing, boric acid used for cross-linking are permeated into a film by immersing the film in an aqueous solution as mentioned above, instead of this method, a method may be adopted that arbitrary types and amounts may be added before film formation of the process (2) and before or after preparation of a mixed solution in the process (1). And both methods may be used in combination. However, when high temperatures (for example, no less than 80° C.) is required in the process (3) at the time of stretching etc., in the view point of heat resistance of the dichroic absorbing material, the process (4) for dispersing and dyeing the dichroic absorbing material may be desirably performed after the process (3).

In the method for manufacturing the polarizer, the process (1) and the process (2) are generally performed in this order, and then the process (3) and the process (4) may be performed in any order. The energy ray applying process (5) is performed preferably after the process (3) is completed, and more preferably after the processes (3) and (4) are completed.

A thickness of the obtained polarizer (film) is not especially limited, in general, but it is 1 μm to 3 mm, preferably 5 μm to 1 mm, and more preferably 10 to 500 μm.

A polarizer obtained in this way does not especially have a relationship in size between a refractive index of the birefringent material forming minute domains and a refractive index of the matrix resin in a stretching direction, whose stretching direction is in a Δn¹ direction and two directions perpendicular to a stretching axis are Δn² directions. Moreover, the stretching direction of a dichroic absorbing material is in a direction demonstrating maximal absorption, and thus a polarizer having a maximally demonstrated effect of absorption and scattering may be realized.

According to common techniques, the resulting polarizer may form a polarizing plate that comprises the polarizer and a transparent protective layer provided on at least one side of the polarizer. The polarizer or the polarizing plate may be stacked on any optical film to form a laminated optical film.

In the above production method, a polarizer may be obtained without performing the energy ray applying process (5), and then the energy ray applying process may be performed in the same manner as described above after a transparent protective layer is adhered through an adhesive to the polarizer in the process of preparing a polarizing plate, so that the alignment of the birefringent material having liquid crystalline properties can be fixed.

In the above production method, a polarizer or a polarizing plate using the polarizer may be obtained without performing the energy ray applying process (5), and then the energy ray applying process may be performed in the same manner as described above after an optical film is adhered through an adhesive to the polarizer or polarizing plate in the process of preparing a laminated optical film, so that the alignment of the birefringent material having liquid crystalline properties can be fixed.

If highly penetrating energy rays such as electron beams, X-rays and gamma rays are used in the energy ray applying process (5), a solventless electron-beam-curable adhesive or pressure-sensitive adhesive may be used to adhere the polarizer to the transparent protective layer and/or to adhere the polarizing plate to the optical film, so that the adhesive and the liquid crystalline material in the polarizer can be simultaneously cured. This is advantageous in terms of energy efficiency and a reduction in production line as compared with the case where a thermosetting adhesive, a moisture curing adhesive or the like is used.

The transparent protective layer used for the polarizing plate may be prepared as an application layer by polymers, or a laminated layer of films. Proper transparent materials may be used as a transparent polymer or a film material that forms the transparent protective layer, and the material having outstanding transparency, mechanical strength, heat stability and outstanding moisture interception property, etc. may be preferably used. As materials of the above-mentioned protective layer, for example, polyester type polymers, such as polyethylene terephthalate and polyethylenenaphthalate; cellulose type polymers, such as diacetyl cellulose and triacetyl cellulose; acrylics type polymer, such as poly methylmethacrylate; styrene type polymers, such as polystyrene and acrylonitrile-styrene copolymer (AS resin); polycarbonate type polymer may be mentioned. Besides, as examples of the polymer forming a protective film, polyolefin type polymers, such as polyethylene, polypropylene, polyolefin that has cyclo-type or norbornene structure, ethylene-propylene copolymer; vinyl chloride type polymer; amide type polymers, such as nylon and aromatic polyamide; imide type polymers; sulfone type polymers; polyether sulfone type polymers; polyether-ether ketone type polymers; poly phenylene sulfide type polymers; vinyl alcohol type polymer; vinylidene chloride type polymers; vinyl butyral type polymers; arylate type polymers; polyoxymethylene type polymers; epoxy type polymers; or blend polymers of the above-mentioned polymers may be mentioned.

Moreover, as is described in Japanese Patent Laid-Open Publication No. 2001-343529 (WO 01/37007), polymer films, for example, resin compositions including (A) thermoplastic resins having substituted and/or non-substituted imido group is in side chain, and (B) thermoplastic resins having substituted and/or non-substituted phenyl and nitrile group in sidechain may be mentioned. As an illustrative example, a film may be mentioned that is made of a resin composition including alternating copolymer comprising iso-butylene and N-methyl maleimide, and acrylonitrile-styrene copolymer. A film comprising mixture extruded article of resin compositions etc. may be used.

As a transparent protection film, if polarization property and durability are taken into consideration, cellulose based polymer, such as triacetyl cellulose, is preferable, and especially triacetyl cellulose film is suitable. In general, a thickness of a transparent protection film is 500 μm or less, preferably 1 to 300 μm, and especially preferably 5 to 300 μm. In addition, when transparent protection films are provided on both sides of the polarizer, transparent protection films comprising same polymer material may be used on both of a front side and a back side, and transparent protection films comprising different polymer materials etc. may be used.

Moreover, it is preferable that the transparent protection film may have as little coloring as possible. Accordingly, a protection film having a phase difference value in a film thickness direction represented by Rth=[(nx+ny)/2−nz]×d of −90 nm to +75 nm (where, nx and ny represent principal indices of refraction in a film plane, nz represents refractive index in a film thickness direction, and d represents a film thickness) may be preferably used. Thus, coloring (optical coloring) of polarizing plate resulting from a protection film may mostly be cancelled using a protection film having a phase difference value (Rth) of −90 nm to +75 nm in a thickness direction. The phase difference value (Rth) in a thickness direction is preferably −80 nm to +60 nm, and especially preferably −70 nm to +45 nm.

A hard coat layer may be prepared, or antireflection processing, processing aiming at sticking prevention, diffusion or anti glare may be performed onto the face on which the polarizing film of the above described transparent protective film has not been adhered.

A hard coat processing is applied for the purpose of protecting the surface of the polarizing plate from damage, and this hard coat film may be formed by a method in which, for example, a curable coated film with excellent hardness, slide property etc. is added on the surface of the protective film using suitable ultraviolet curable type resins, such as acrylic type and silicone type resins. Antireflection processing is applied for the purpose of antireflection of outdoor daylight on the surface of a polarizing plate and it may be prepared by forming an antireflection film according to the conventional method etc. Besides, a sticking prevention processing is applied for the purpose of adherence prevention with adjoining layer.

In addition, an anti glare processing is applied in order to prevent a disadvantage that outdoor daylight reflects on the surface of a polarizing plate to disturb visual recognition of transmitting light through the polarizing plate, and the processing may be applied, for example, by giving a fine concavo-convex structure to a surface of the protective film using, for example, a suitable method, such as rough surfacing treatment method by sandblasting or embossing and a method of combining transparent fine particle. As a fine particle combined in order to form a fine concavo-convex structure on the above-mentioned surface, transparent fine particles whose average particle size is 0.5 to 50 μm, for example, such as inorganic type fine particles that may have conductivity comprising silica, alumina, titania, zirconia, tin oxides, indium oxides, cadmium oxides, antimony oxides, etc., and organic type fine particles comprising cross-linked of non-cross-linked polymers may be used. When forming fine concavo-convex structure on the surface, the amount of fine particle used is usually about 2 to 50 weight parts to the transparent resin 100 weight part that forms the fine concavo-convex structure on the surface, and preferably 5 to 25 weight part. An anti glare layer may serve as a diffusion layer (viewing angle expanding function etc.) for diffusing transmitting light through the polarizing plate and expanding a viewing angle etc.

In addition, the above-mentioned antireflection layer, sticking prevention layer, diffusion layer, anti glare layer, etc. may be built in the protective film itself, and also they may be prepared as an optical layer different from the protective layer.

Adhesives are used for adhesion processing of the above described polarizing film and the transparent protective film. As adhesives, isocyanate derived adhesives, polyvinyl alcohol derived adhesives, gelatin derived adhesives, vinyl polymers derived latex type, aqueous polyesters derived adhesives, etc. may be mentioned. The above-described adhesives are usually used as adhesives comprising aqueous solution, and usually contain solid of 0.5 to 60% by weight. If high energy rays such as electron beams are used, a solventless electron-beam-curable adhesive may be used. The solventless electron-beam-curable adhesive may be of an epoxy type, a urethane type, an acrylic type, a silicone type, or the like. Any of these solventless electron-beam-curable adhesives and the liquid crystalline material in the polarizer may be cured at the same time with high energy rays in the energy ray applying process (5).

The above described transparent protective film and the polarizing film is adhered by using the above described adhesives. The application of adhesives may be performed to any of the transparent protective film or the polarizing film, and may be performed to both of them. After adhered, drying process is given and the adhesion layer comprising applied dry layer is formed. Adhering process of the polarizing film and the transparent protective film may be performed using a roll laminator etc. Although a thickness of the adhesion layer is not especially limited, it is usually approximately 0.1 to 5 μm.

A polarizing plate of the present invention may be used in practical use as an optical film laminated with other optical layers. Although there is especially no limitation about the optical layers, one layer or two layers or more of optical layers, which may be used for formation of a liquid crystal display etc., such as a reflector, a transflective plate, a retardation plate (a half wavelength plate and a quarter wavelength plate included), and a viewing angle compensation film, may be used. Especially preferable polarizing plates are; a reflection type polarizing plate or a transflective type polarizing plate in which a reflector or a transflective reflector is further laminated onto a polarizing plate of the present invention; an elliptically polarizing plate or a circular polarizing plate in which a retardation plate is further laminated onto the polarizing plate; a wide viewing angle polarizing plate in which a viewing angle compensation film is further laminated onto the polarizing plate; or a polarizing plate in which a brightness enhancement film is further laminated onto the polarizing plate.

A reflective layer is prepared on a polarizing plate to give a reflection type polarizing plate, and this type of plate is used for a liquid crystal display in which an incident light from a view side (display side) is reflected to give a display. This type of plate does not require built-in light sources, such as a backlight, but has an advantage that a liquid crystal display may easily be made thinner. A reflection type polarizing plate may be formed using suitable methods, such as a method in which a reflective layer of metal etc. is, if required, attached to one side of a polarizing plate through a transparent protective layer etc.

As an example of a reflection type polarizing plate, a plate may be mentioned on which, if required, a reflective layer is formed using a method of attaching a foil and vapor deposition film of reflective metals, such as aluminum, to one side of a matte treated protective film. Moreover, a different type of plate with a fine concavo-convex structure on the surface obtained by mixing fine particle into the above-mentioned protective film, on which a reflective layer of concavo-convex structure is prepared, may be mentioned. The reflective layer that has the above-mentioned fine concavo-convex structure diffuses incident light by random reflection to prevent directivity and glaring appearance, and has an advantage of controlling unevenness of light and darkness etc. Moreover, the protective film containing the fine particle has an advantage that unevenness of light and darkness may be controlled more effectively, as a result that an incident light and its reflected light that is transmitted through the film are diffused. A reflective layer with fine concavo-convex structure on the surface effected by a surface fine concavo-convex structure of a protective film may be formed by a method of attaching a metal to the surface of a transparent protective layer directly using, for example, suitable methods of a vacuum evaporation method, such as a vacuum deposition method, an ion plating method, and a sputtering method, and a plating method etc.

Instead of a method in which a reflection plate is directly given to the protective film of the above-mentioned polarizing plate, a reflection plate may also be used as a reflective sheet constituted by preparing a reflective layer on the suitable film for the transparent film. In addition, since a reflective layer is usually made of metal, it is desirable that the reflective side is covered with a protective film or a polarizing plate etc. when used, from a viewpoint of preventing deterioration in reflectance by oxidation, of maintaining an initial reflectance for a long period of time and of avoiding preparation of a protective layer separately etc.

In addition, a transflective type polarizing plate may be obtained by preparing the above-mentioned reflective layer as a transflective type reflective layer, such as a half-mirror etc. that reflects and transmits light. A transflective type polarizing plate is usually prepared in the backside of a liquid crystal cell and it may form a liquid crystal display unit of a type in which a picture is displayed by an incident light reflected from a view side (display side) when used in a comparatively well-lighted atmosphere. And this unit displays a picture, in a comparatively dark atmosphere, using embedded type light sources, such as a back light built in backside of a transflective type polarizing plate. That is, the transflective type polarizing plate is useful to obtain of a liquid crystal display of the type that saves energy of light sources, such as a back light, in a well-lighted atmosphere, and can be used with a built-in light source if needed in a comparatively dark atmosphere etc.

The above-mentioned polarizing plate may be used as elliptically polarizing plate or circularly polarizing plate on which the retardation plate is laminated. A description of the above-mentioned elliptically polarizing plate or circularly polarizing plate will be made in the following paragraph. These polarizing plates change linearly polarized light into elliptically polarized light or circularly polarized light, elliptically polarized light or circularly polarized light into linearly polarized light or change the polarization direction of linearly polarization by a function of the retardation plate. As a retardation plate that changes circularly polarized light into linearly polarized light or linearly polarized light into circularly polarized light, what is called a quarter wavelength plate (also called λ/4 plate) is used. Usually, half-wavelength plate (also called λ/2 plate) is used, when changing the polarization direction of linearly polarized light.

Elliptically polarizing plate is effectively used to give a monochrome display without above-mentioned coloring by compensating (preventing) coloring (blue or yellow color) produced by birefringence of a liquid crystal layer of a super twisted nematic (STN) type liquid crystal display. Furthermore, a polarizing plate in which three-dimensional refractive index is controlled may also preferably compensate (prevent) coloring produced when a screen of a liquid crystal display is viewed from an oblique direction. Circularly polarizing plate is effectively used, for example, when adjusting a color tone of a picture of a reflection type liquid crystal display that provides a colored picture, and it also has function of antireflection. For example, a retardation plate may be used that compensates coloring and viewing angle, etc. caused by birefringence of various wavelength plates or liquid crystal layers etc. Besides, optical characteristics, such as retardation, may be controlled using laminated layer with two or more sorts of retardation plates having suitable retardation value according to each purpose. As retardation plates, birefringence films formed by stretching films comprising suitable polymers, such as polycarbonates, norbornene type resins, polyvinyl alcohols, polystyrenes, poly methyl methacrylates, polypropylene; polyarylates and polyamides; oriented films comprising liquid crystal materials, such as liquid crystal polymer; and films on which an alignment layer of a liquid crystal material is supported may be mentioned. A retardation plate may be a retardation plate that has a proper phase difference according to the purposes of use, such as various kinds of wavelength plates and plates aiming at compensation of coloring by birefringence of a liquid crystal layer and of visual angle, etc., and may be a retardation plate in which two or more sorts of retardation plates is laminated so that optical properties, such as retardation, may be controlled.

The above-mentioned elliptically polarizing plate and an above-mentioned reflected type elliptically polarizing plate are laminated plate combining suitably a polarizing plate or a reflection type polarizing plate with a retardation plate. This type of elliptically polarizing plate etc. may be manufactured by combining a polarizing plate (reflected type) and a retardation plate, and by laminating them one by one separately in the manufacture process of a liquid crystal display. On the other hand, the polarizing plate in which lamination was beforehand carried out and was obtained as an optical film, such as an elliptically polarizing plate, is excellent in a stable quality, a workability in lamination etc., and has an advantage in improved manufacturing efficiency of a liquid crystal display.

A viewing angle compensation film is a film for extending viewing angle so that a picture may look comparatively clearly, even when it is viewed from an oblique direction not from vertical direction to a screen. As such a viewing angle compensation retardation plate, in addition, a film having birefringence property that is processed by uniaxial stretching or orthogonal bidirectional stretching and a bidriectionally stretched film as inclined orientation film etc. may be used. As inclined orientation film, for example, a film obtained using a method in which a heat shrinking film is adhered to a polymer film, and then the combined film is heated and stretched or shrunk under a condition of being influenced by a shrinking force, or a film that is oriented in oblique direction may be mentioned. The viewing angle compensation film is suitably combined for the purpose of prevention of coloring caused by change of visible angle based on retardation by liquid crystal cell etc. and of expansion of viewing angle with good visibility.

Besides, a compensation plate in which an optical anisotropy layer consisting of an alignment layer of liquid crystal polymer, especially consisting of an inclined alignment layer of discotic liquid crystal polymer is supported with triacetyl cellulose film may preferably be used from a viewpoint of attaining a wide viewing angle with good visibility.

The polarizing plate with which a polarizing plate and a brightness enhancement film are adhered together is usually used being prepared in a backside of a liquid crystal cell. A brightness enhancement film shows a characteristic that reflects linearly polarized light with a predetermined polarization axis, or circularly polarized light with a predetermined direction, and that transmits other light, when natural light by back lights of a liquid crystal display or by reflection from a back-side etc., comes in. The polarizing plate, which is obtained by laminating a brightness enhancement film to a polarizing plate, thus does not transmit light without the predetermined polarization state and reflects it, while obtaining transmitted light with the predetermined polarization state by accepting a light from light sources, such as a backlight. This polarizing plate makes the light reflected by the brightness enhancement film further reversed through the reflective layer prepared in the backside and forces the light re-enter into the brightness enhancement film, and increases the quantity of the transmitted light through the brightness enhancement film by transmitting a part or all of the light as light with the predetermined polarization state. The polarizing plate simultaneously supplies polarized light that is difficult to be absorbed in a polarizer, and increases the quantity of the light usable for a liquid crystal picture display etc., and as a result luminosity may be improved. That is, in the case where the light enters through a polarizer from backside of a liquid crystal cell by the back light etc. without using a brightness enhancement film, most of the light, with a polarization direction different from the polarization axis of a polarizer, is absorbed by the polarizer, and does not transmit through the polarizer. This means that although influenced with the characteristics of the polarizer used, about 50 percent of light is absorbed by the polarizer, the quantity of the light usable for a liquid crystal picture display etc. decreases so much, and a resulting picture displayed becomes dark. A brightness enhancement film does not enter the light with the polarizing direction absorbed by the polarizer into the polarizer but reflects the light once by the brightness enhancement film, and further makes the light reversed through the reflective layer etc. prepared in the backside to re-enter the light into the brightness enhancement film. By this above-mentioned repeated operation, only when the polarization direction of the light reflected and reversed between the both becomes to have the polarization direction which may pass a polarizer, the brightness enhancement film transmits the light to supply it to the polarizer. As a result, the light from a backlight may be efficiently used for the display of the picture of a liquid crystal display to obtain a bright screen.

A diffusion plate may also be prepared between brightness enhancement film and the above described reflective layer, etc. A polarized light reflected by the brightness enhancement film goes to the above described reflective layer etc., and the diffusion plate installed diffuses passing light uniformly and changes the light state into depolarization at the same time. That is, the diffusion plate returns polarized light to natural light state. Steps are repeated where light, in the unpolarized state, i.e., natural light state, reflects through reflective layer and the like, and again goes into brightness enhancement film through diffusion plate toward reflective layer and the like. Diffusion plate that returns polarized light to the natural light state is installed between brightness enhancement film and the above described reflective layer, and the like, in this way, and thus a uniform and bright screen may be provided while maintaining brightness of display screen, and simultaneously controlling non-uniformity of brightness of the display screen. By preparing such diffusion plate, it is considered that number of repetition times of reflection of a first incident light increases with sufficient degree to provide uniform and bright display screen conjointly with diffusion function of the diffusion plate.

The suitable films are used as the above-mentioned brightness enhancement film. Namely, multilayer thin film of a dielectric substance; a laminated film that has the characteristics of transmitting a linearly polarized light with a predetermined polarizing axis, and of reflecting other light, such as the multilayer laminated film of the thin film having a different refractive-index anisotropy; an aligned film of cholesteric liquid-crystal polymer; a film that has the characteristics of reflecting a circularly polarized light with either left-handed or right-handed rotation and transmitting other light, such as a film on which the aligned cholesteric liquid crystal layer is supported may be mentioned.

Therefore, in the brightness enhancement film of a type that transmits a linearly polarized light having the above-mentioned predetermined polarization axis, by arranging the polarization axis of the transmitted light and entering the light into a polarizing plate as it is, the absorption loss by the polarizing plate is controlled and the polarized light can be transmitted efficiently. On the other hand, in the brightness enhancement film of a type that transmits a circularly polarized light as a cholesteric liquid-crystal layer, the light may be entered into a polarizer as it is, but it is desirable to enter the light into a polarizer after changing the circularly polarized light to a linearly polarized light through a retardation plate, taking control an absorption loss into consideration. In addition, a circularly polarized light is convertible into a linearly polarized light using a quarter wavelength plate as the retardation plate.

A retardation plate that works as a quarter wavelength plate in a wide wavelength ranges, such as a visible-light band, is obtained by a method in which a retardation layer working as a quarter wavelength plate to a pale color light with a wavelength of 550 nm is laminated with a retardation layer having other retardation characteristics, such as a retardation layer working as a half-wavelength plate. Therefore, the retardation plate located between a polarizing plate and a brightness enhancement film may consist of one or more retardation layers.

In addition, also in a cholesteric liquid-crystal layer, a layer reflecting a circularly polarized light in a wide wavelength ranges, such as a visible-light band, may be obtained by adopting a configuration structure in which two or more layers with different reflective wavelength are laminated together. Thus a transmitted circularly polarized light in a wide wavelength range may be obtained using this type of cholesteric liquid-crystal layer.

Moreover, the polarizing plate may consist of multi-layered film of laminated layers of a polarizing plate and two of more of optical layers as the above-mentioned separated type polarizing plate. Therefore, a polarizing plate may be a reflection type elliptically polarizing plate or a semi-transmission type elliptically polarizing plate, etc. in which the above-mentioned reflection type polarizing plate or a transflective type polarizing plate is combined with above described retardation plate respectively.

Although an optical film with the above described optical layer laminated to the polarizing plate may be formed by a method in which laminating is separately carried out sequentially in manufacturing process of a liquid crystal display etc., an optical film in a form of being laminated beforehand has an outstanding advantage that it has excellent stability in quality and assembly workability, etc., and thus manufacturing processes ability of a liquid crystal display etc. may be raised. Proper adhesion means, such as an adhesive layer, may be used for laminating. On the occasion of adhesion of the above described polarizing plate and other optical films, the optical axis may be set as a suitable configuration angle according to the target retardation characteristics etc.

In the polarizing plate mentioned above and the optical film in which at least one layer of the polarizing plate is laminated, an adhesive layer may also be prepared for adhesion with other members, such as a liquid crystal cell etc. As pressure sensitive adhesive that forms adhesive layer is not especially limited, and, for example, acrylic type polymers; silicone type polymers; polyesters, polyurethanes, polyamides, polyethers; fluorine type and rubber type polymers may be suitably selected as a base polymer. Especially, a pressure sensitive adhesive such as acrylics type pressure sensitive adhesives may be preferably used, which is excellent in optical transparency, showing adhesion characteristics with moderate wettability, cohesiveness and adhesive property and has outstanding weather resistance, heat resistance, etc.

Moreover, an adhesive layer with low moisture absorption and excellent heat resistance is desirable. This is because those characteristics are required in order to prevent foaming and peeling-off phenomena by moisture absorption, in order to prevent decrease in optical characteristics and curvature of a liquid crystal cell caused by thermal expansion difference etc. and in order to manufacture a liquid crystal display excellent in durability with high quality.

The adhesive layer may contain additives, for example, such as natural or synthetic resins, adhesive resins, glass fibers, glass beads, metal powder, fillers comprising other inorganic powder etc., pigments, colorants and antioxidants. Moreover, it may be an adhesive layer that contains fine particle and shows optical diffusion nature.

Proper method may be carried out to attach an adhesive layer to one side or both sides of the optical film. As an example, about 10 to 40 weight % of the pressure sensitive adhesive solution in which a base polymer or its composition is dissolved or dispersed, for example, toluene or ethyl acetate or a mixed solvent of these two solvents is prepared. A method in which this solution is directly applied on a polarizing plate top or an optical film top using suitable developing methods, such as flow method and coating method, or a method in which an adhesive layer is once formed on a separator, as mentioned above, and is then transferred on a polarizing plate or an optical film may be mentioned.

An adhesive layer may also be prepared on one side or both sides of a polarizing plate or an optical film as a layer in which pressure sensitive adhesives with different composition or different kind etc. are laminated together. Moreover, when adhesive layers are prepared on both sides, adhesive layers that have different compositions, different kinds or thickness, etc. may also be used on front side and backside of a polarizing plate or an optical film. Thickness of an adhesive layer may be suitably determined depending on a purpose of usage or adhesive strength, etc., and generally is 1 to 500 μm, preferably 5 to 200 μm, and more preferably 10 to 100 μm.

A temporary separator is attached to an exposed side of an adhesive layer to prevent contamination etc., until it is practically used. Thereby, it can be prevented that foreign matter contacts adhesive layer in usual handling. As a separator, without taking the above-mentioned thickness conditions into consideration, for example, suitable conventional sheet materials that is coated, if necessary, with release agents, such as silicone type, long chain alkyl type, fluorine type release agents, and molybdenum sulfide may be used. As a suitable sheet material, plastics films, rubber sheets, papers, cloths, no woven fabrics, nets, foamed sheets and metallic foils or laminated sheets thereof may be used.

In addition, in the present invention, ultraviolet absorbing property may be given to the above-mentioned each layer, such as a polarizer for a polarizing plate, a transparent protective film and an optical film etc. and an adhesive layer, using a method of adding UV absorbents, such as salicylic acid ester type compounds, benzophenol type compounds, benzotriazol type compounds, cyano acrylate type compounds, and nickel complex salt type compounds.

An optical film of the present invention may be preferably used for manufacturing various equipment, such as liquid crystal display, etc. Assembling of a liquid crystal display may be carried out according to conventional methods. That is, a liquid crystal display is generally manufactured by suitably assembling several parts such as a liquid crystal cell, optical films and, if necessity, lighting system, and by incorporating driving circuit. In the present invention, except that an optical film by the present invention is used, there is especially no limitation to use any conventional methods. Also any liquid crystal cell of arbitrary type, such as TN type, and STN type, π type may be used.

Suitable liquid crystal displays, such as liquid crystal display with which the above-mentioned optical film has been located at one side or both sides of the liquid crystal cell, and with which a backlight or a reflector is used for a lighting system may be manufactured. In this case, the optical film by the present invention may be installed in one side or both sides of the liquid crystal cell. When installing the optical films in both sides, they may be of the same type or of different type. Furthermore, in assembling a liquid crystal display, suitable parts, such as diffusion plate, anti-glare layer, antireflection film, protective plate, prism array, lens array sheet, optical diffusion plate, and backlight, may be installed in suitable position in one layer or two or more layers.

Subsequently, organic electro luminescence equipment (organic EL display) will be explained. Generally, in organic EL display, a transparent electrode, an organic luminescence layer and a metal electrode are laminated on a transparent substrate in an order configuring an illuminant (organic electro luminescence illuminant). Here, an organic luminescence layer is a laminated material of various organic thin films, and much compositions with various combination are known, for example, a laminated material of hole injection layer comprising triphenylamine derivatives etc., a luminescence layer comprising fluorescent organic solids, such as anthracene; a laminated material of electronic injection layer comprising such a luminescence layer and perylene derivatives, etc.; laminated material of these hole injection layers, luminescence layer, and electronic injection layer etc.

An organic EL display emits light based on a principle that positive hole and electron are injected into an organic luminescence layer by impressing voltage between a transparent electrode and a metal electrode, the energy produced by recombination of these positive holes and electrons excites fluorescent substance, and subsequently light is emitted when excited fluorescent substance returns to ground state. A mechanism called recombination which takes place in a intermediate process is the same as a mechanism in common diodes, and, as is expected, there is a strong non-linear relationship between electric current and luminescence strength accompanied by rectification nature to applied voltage.

In an organic EL display, in order to take out luminescence in an organic luminescence layer, at least one electrode must be transparent. The transparent electrode usually formed with transparent electric conductor, such as indium tin oxide (ITO), is used as an anode. On the other hand, in order to make electronic injection easier and to increase luminescence efficiency, it is important that a substance with small work function is used for cathode, and metal electrodes, such as Mg—Ag and Al—Li, are usually used.

In organic EL display of such a configuration, an organic luminescence layer is formed by a very thin film about 10 nm in thickness. For this reason, light is transmitted nearly completely through organic luminescence layer as through transparent electrode. Consequently, since the light that enters, when light is not emitted, as incident light from a surface of a transparent substrate and is transmitted through a transparent electrode and an organic luminescence layer and then is reflected by a metal electrode, appears in front surface side of the transparent substrate again, a display side of the organic EL display looks like mirror if viewed from outside.

In an organic EL display containing an organic electro luminescence illuminant equipped with a transparent electrode on a surface side of an organic luminescence layer that emits light by impression of voltage, and at the same time equipped with a metal electrode on a back side of organic luminescence layer, a retardation plate may be installed between these transparent electrodes and a polarizing plate, while preparing the polarizing plate on the surface side of the transparent electrode.

Since the retardation plate and the polarizing plate have function polarizing the light that has entered as incident light from outside and has been reflected by the metal electrode, they have an effect of making the mirror surface of metal electrode not visible from outside by the polarization action. If a retardation plate is configured with a quarter wavelength plate and the angle between the two polarization directions of the polarizing plate and the retardation plate is adjusted to π/4, the mirror surface of the metal electrode may be completely covered.

This means that only linearly polarized light component of the external light that enters as incident light into this organic EL display is transmitted with the work of polarizing plate. This linearly polarized light generally gives an elliptically polarized light by the retardation plate, and especially the retardation plate is a quarter wavelength plate, and moreover when the angle between the two polarization directions of the polarizing plate and the retardation plate is adjusted to π/4, it gives a circularly polarized light.

This circularly polarized light is transmitted through the transparent substrate, the transparent electrode and the organic thin film, and is reflected by the metal electrode, and then is transmitted through the organic thin film, the transparent electrode and the transparent substrate again, and is turned into a linearly polarized light again with the retardation plate. And since this linearly polarized light lies at right angles to the polarization direction of the polarizing plate, it cannot be transmitted through the polarizing plate. As the result, mirror surface of the metal electrode may be completely covered.

### EXAMPLES

Examples of this invention will, hereinafter, be shown, and specific descriptions will be provided. In addition, “parts” in following sections represents parts by weight.

### Example 1

### Preparation of Iodine Type Polarizer

An aqueous polyvinyl alcohol solution with a solids content of 13% by weight containing a dissolved polyvinyl alcohol resin with a polymerization degree of 2400 and a saponification degree of 98.5%; a liquid crystalline monomer with mesogenic groups each having one acryloyl group at each of both ends (with a nematic liquid crystal temperature range of 55 to 75° C.); glycerin; and a photopolymerization initiator (Irgacure 184 manufactured by Ciba Specialty Chemicals Inc.) were mixed such that the ratio of the polyvinyl alcohol, the liquid crystalline monomer, the glycerin, and the photopolymerization initiator was 100:3:15:0.015 (by weight). The mixture was heated to a temperature not lower than the liquid crystal temperature range and stirred in a homomixer to form a mixture solution. The mixture solution was allowed to stand at room temperature (23° C.) so that air bubbles were removed from the mixture solution. Thereafter, the mixture solution was applied by a casting method and subsequently dried to form a 70 μm-thick whitish mixture film. The mixture film was heat-treated at 130° C. for 10 minutes.

The mixture film was wet-stretched by the processes of: (i) dipping the film in a water bath at 30° C. to swell it and stretching it three times; (ii) dipping the film in an aqueous solution of iodine and potassium iodide (1:6 in weight ratio) with a concentration of 0.32% by weight at 30° C. to dye it; (iii) dipping the film in an aqueous solution of 3% by weight boric acid at 30° C. to crosslink it; (iv) then dipping the film in an aqueous solution of 3.5% by weight boric acid at 55° C. and stretching it twice (totally six times); (v) dipping the film in an aqueous solution of 5% by weight potassium iodide at 30° C. to adjust the color hue. The film was then subject to the processes of: (vi) drying it at 50° C. for five minutes; and (vii) then irradiating it with ultraviolet rays from a high pressure mercury UV lamp at an exposure dose of 250 mJ/m², resulting in a polarizer.

### (Confirmation of Generation of Anisotropic Scattering and Measurement of Refractive Index)

The obtained polarizer was observed under a polarization microscope and it was able to be confirmed that numberless dispersed micro regions of a liquid crystalline monomer were formed in a polyvinyl alcohol matrix. The liquid crystalline monomer is oriented in a stretching direction and an average size of micro regions in the stretching direction (Δn² direction) was in the range of from 1 to 2 μm.

Refractive indices of the matrix and the micro region were separately measured. Measurement was conducted at 20° C. A refractive index of a stretched film constituted only of a polyvinyl alcohol film stretched in the same conditions as the wet stretching was measured with an Abbe's refractometer (measurement light wavelength with 589 nm) to obtain a refractive index in the stretching direction (Δn¹ direction)=1.54 and a refractive index in Δn² direction=1.52. Refractive indexes (nₑ: an extraordinary light refractive index and n₀: an ordinary light refractive index) of a liquid crystalline monomer were measured. An ordinary light refractive index n₀ was measured of the liquid crystalline monomer orientation-coated on a high refractive index glass which is vertical alignment-treated with an Abbe's refractometer (measurement light with 589 nm). On the other hand, the liquid crystalline monomer is injected into a liquid crystal cell which is homogenous alignment-treated and a retardation (Δn×d) was measured with an automatic birefringence measurement instrument (automatic birefringence meter KOBRA21ADH) manufactured by Ohoji Keisokuki K.K.) and a cell gap (d) was measured separately with an optical interference method to calculate Δn from retardation/cell gap and to obtain the sum of Δn and n₀ as nₑ. An extraordinary light refractive index nₑ (corresponding to a refractive index in the Δn¹ direction)=1.66 and n₀ (corresponding to a refractive index of Δn² direction)=1.53. Therefore, calculation was resulted in Δn¹=1.66−1.54=0.12 and Δn²=1.52−1.52=0.00. It was confirmed from the measurement described above that a desired anisotropic scattering was able to occur.

### Reference Example 1

A polarizer was obtained using the process of Example 1 except that the ultraviolet irradiation process (vii) was not performed. It was demonstrated that the resulting polarizer showed anisotropic scattering and refractive index similarly to that of Example 1.

### Comparative Example 1

A polarizer was prepared using the process of Example 1 except that neither the liquid crystalline monomer nor the photopolymerization initiator was used and that the ultraviolet irradiation process (vii) was not performed.

### Example 2

### Preparation of Polarizing Plate

An adhesive composed of an aqueous solution of 7% by weight polyvinyl alcohol was applied to both sides of the polarizer obtained in Example 1, and then a triacetylcellulose film (80 μm in thickness), as transparent protective, whose surface to be adhered was saponified with an aqueous sodium hydroxide solution was adhered to each side of the polarizer to form a polarizing plate.

### Reference Example 2

A polarizing plate was obtained using the process of Example 2 except that the polarizer obtained in Reference Example 1 was used in place of the polarizer obtained in Example 1.

### Comparative Example 2

A polarizing plate was obtained using the process of Example 2 except that the polarizer obtained in Comparative Example 1 was used in place of the polarizer obtained in Example 1.

### Example 3

### Preparation of Dye Type Polarizer

An aqueous polyvinyl alcohol solution with a solids content of 13% by weight containing a dissolved polyvinyl alcohol resin with a polymerization degree of 2400 and a saponification degree of 98.5%; a liquid crystalline monomer with mesogenic groups each having one acryloyl group at each of both ends (with a nematic liquid crystal temperature range of 55 to 75° C.); glycerin; and a photopolymerization initiator (Irgacure 184 manufactured by Ciba Specialty Chemicals Inc.) were mixed such that the ratio of the polyvinyl alcohol, the liquid crystalline monomer, the glycerin, and the photopolymerization initiator was 100:3:15:0.015 (by weight). The mixture was heated to a temperature not lower than the liquid crystal temperature range and stirred in a homomixer to form a mixture solution. The mixture solution was allowed to stand at room temperature (23° C.) so that air bubbles were removed from the mixture solution. Thereafter, the mixture solution was applied by a casting method and subsequently dried to form a 70 μm-thick whitish mixture film. The mixture film was heat-treated at 130° C. for 10 minutes.

The mixture film was swelled in a water bath at 30° C. and then stretched three times while being dipped in a 30° C. dye bath composed of an aqueous solution containing a dichroic dye (Congo red manufactured by Kishida Chemical Co., Ltd.). The film was then stretched such that the total stretch ratio reached six times, while being dipped in a crosslinking bath composed of an aqueous solution of 3% by weight boric acid at 50° C. The film was further dipped in an aqueous solution of 4% by weight boric acid to be crosslinked. The film was subsequently dried at 50° C. for five minutes and then irradiated with ultraviolet rays from a high pressure mercury UV lamp at an exposure does of 250 mJ/m², resulting in a polarizer. It was demonstrated that the resulting polarizer showed anisotropic scattering and refractive index similarly to that of Example 1.

### Reference Example 3

A polarizer was obtained using the process of Example 3 except that the ultraviolet irradiation process was not performed. It was demonstrated that the resulting polarizer showed anisotropic scattering and refractive index similarly to that of Example 1.

### Example 4

An iodine type polarizer was prepared using the process of Example 1 except that no photopolymerization initiator was added when the mixture solution was prepared and that the application of 30 kGy of electron beams was performed in place of the application of ultraviolet rays. It was demonstrated that the resulting polarizer showed anisotropic scattering and refractive index similarly to that of Example 1.

### Reference Example 4

A polarizer was obtained using the process of Example 4 except that the electron beam irradiation process was not performed. It was demonstrated that the resulting polarizer showed anisotropic scattering and refractive index similarly to that of Example 1.

### Example 5

A norbornene type protective film (Zeonoa 40 μm in thickness manufactured by Zeon Corporation) was adhered through a urethane type adhesive (M631-N manufactured by MITSUI CHEMICALS POLYURETHANES, INC.) to both sides of the iodine type polarizer prepared in Reference Example 4, and 40 kGy of electron beams was applied through the protective film to each of both sides, so that a polarizing plate was obtained.

### Reference Example 5

A polarizing plate was obtained using the process of Example 5 except that the electron beam irradiation process was not performed.

### (Evaluation)

Polarizers and polarizing plates (samples) obtained in Examples, Reference examples and Comparative examples were measured for optical properties using a spectrophotometer with integrating sphere (manufactured by Hitachi Ltd. U-4100). Transmittance to each linearly polarized light was measured under conditions in which a completely polarized light obtained through Glan Thompson prism polarizer was set as 100%. Transmittance was calculated based on CIE 1931 standard calorimetric system, and is shown with Y value, for which relative spectral responsivity correction was carried out. Notation k₁ represents a transmittance of a linearly polarized light in a maximum transmittance direction, and k₂ represents a transmittance of a linearly polarized light perpendicular to the direction.

A polarization degree P was calculated with an equation P={(k₁−k₂)/(k₁+k₂)}×100. A transmittance T of a simple substance was calculated with an equation T=(k₁+k₂)/2.

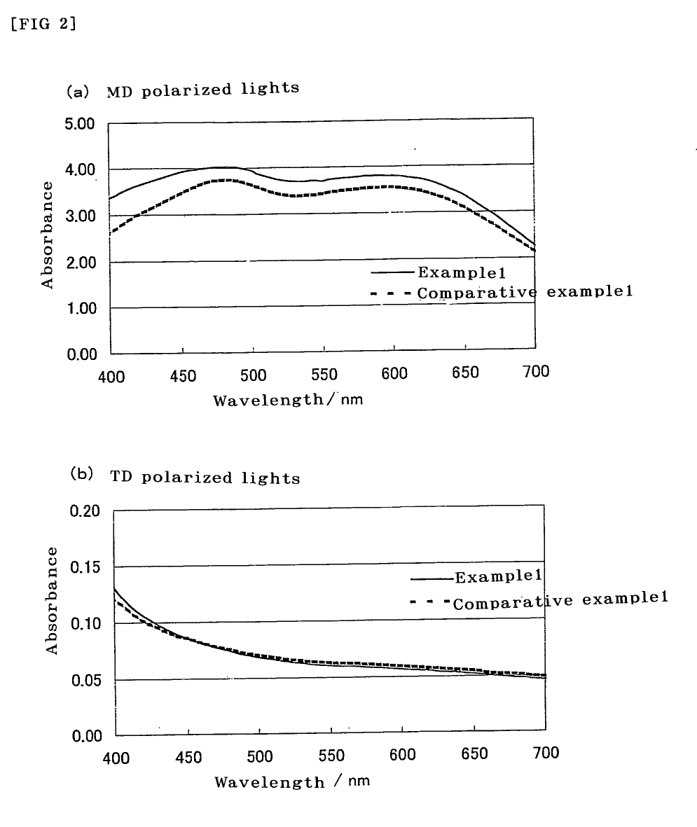

Furthermore, polarizers obtained in Example 1, (Reference example 1) and Comparative example 1 were measured for a polarized light absorption spectrum using a spectrophotometer (manufactured by Hitachi Ltd. U-4100) with Glan Thompson prism. FIG. 2 shows polarized light absorption spectra of polarizers obtained in Example 1 and Comparative example 1. “MD polarized lights” in FIG. 2 (a) represent polarized light absorption spectra when a polarized light with a plane of vibration parallel to a stretching axis enters, and “TD polarized lights” in FIG. 2 (b) represent polarized light absorption spectra when a polarized light with a plane of vibration perpendicular to a stretching axis enters.

In TD polarized lights (=transmission axis of polarizer), in visible range whole band, while absorbance of the polarizers in Example 1 and Comparative example 1 showed almost equal value, in MD polarized lights (=absorption of polarizer+scattering axis), absorbance in the polarizer of Example 1 exceeded absorbance of the polarizer in Comparative example 1 in shorter wavelength side. That is, the above-mentioned result shows that light polarizing performance of the polarizer in Example 1 exceeded performance of the polarizer in Comparative example 1 in a short wavelength side. Since all conditions, such as stretching and dyeing, are equivalent in Example 1 and Comparative example 1, it is thought that orientation of iodine based light absorbing materials is also equivalent. Therefore, as mentioned above, a rise of absorbance in MD polarized light of the polarizer of Example 1 shows that light polarizing performance improved by an effect caused by an effect of anisotropic scattering having been added to absorption by iodine.

In evaluation of unevenness, in a dark room, a sample (polarizer) was arranged on an upper surface of a backlight used for a liquid crystal display, furthermore, a commercially available polarizing plate (NPF-SEG1224DU by NITTO DENKO CORP.) was laminated as an analyzer so that a polarized light axis may intersect perpendicularly. And a level of the unevenness was visually observed on following criterion using the arrangement. x: a level in which unevenness may visually be recognized O: a level in which unevenness may not visually be recognized

TABLE 1

| | Linearly Polarized Light | | | | |
|---|---|---|---|---|---|
| | Transmittance (%) (%) | | | | |
| | Maximum | | Transmittance | | |
| | Transmittance | Perpendicular | of Simple | Polarization | |
| | Direction | Direction | Substance | on Degree | |
| | (k₁) | (k₂) | (%) | (%) | Unevenness |
| Example 1 | 86.9 | 0.03 | 43.47 | 99.97 | ∘ |
| Reference | 86.9 | 0.04 | 43.47 | 99.95 | ∘ |
| Example 1 | | | | | |
| Comparative | 86.9 | 0.06 | 43.48 | 99.93 | x |
| Example 1 | | | | | |
| Example 2 | 86.9 | 0.03 | 43.47 | 99.97 | ∘ |
| Reference | 86.9 | 0.04 | 43.47 | 99.95 | ∘ |
| Example 2 | | | | | |
| Comparative | 86.9 | 0.06 | 43.48 | 99.93 | x |
| Example 2 | | | | | |
| Example 3 | 83 | 1.3 | 42.15 | 98.45 | ∘ |
| Reference | 83 | 1.5 | 42.25 | 98.21 | ∘ |
| Example 3 | | | | | |
| Example 4 | 86.9 | 0.03 | 43.47 | 99.97 | ∘ |
| Reference | 86.9 | 0.04 | 43.47 | 99.95 | ∘ |
| Example 4 | | | | | |
| Example 5 | 86.9 | 0.04 | 43.47 | 99.95 | ∘ |
| Reference | 86.9 | 0.04 | 43.47 | 99.95 | ∘ |
| Example 5 | | | | | |

Table 1 indicates that the polarizer or polarizing plate with the minute domains (the liquid crystalline material) dispersed in the matrix in each of Examples and Reference Examples has a low k₂ value, a high degree of polarization because of the anisotropic scattering effect, and improved polarization performance, as compared with the conventional polarizer or polarizing plate with no minute domain in Comparative Example. In addition, each of Examples has a lower k₂ value and a higher degree of polarization than each of Comparative Examples.

There is no significant difference in optical properties (unevenness) between Examples with energy ray irradiation and Reference Examples without energy ray irradiation. Thus, it has been found that the ultraviolet irradiation does not have the effect of disturbing the alignment of the minute domains or inhibiting the anisotropic scattering effect.

### (Validation of Curing of Minute Domain-Forming Liquid Crystalline Material)

The polarizer or polarizing plate of each of Examples and Reference Examples was cut into 2 cm×2 cm samples. Each sample was placed under the crossed nicols of a polarization microscope such that the absorption axis made an angle of 45′ with the analyzer or polarizer of the microscope. Under the measurement circumstances, a heating unit for the polarization microscope was used to heat the polarizer or polarizing plate sample, while it was observed and evaluated based on the criteria below. The heating was such that it produced high temperatures exceeding the liquid crystal temperature range of the liquid crystalline material but had no adverse effect on the polarizer or polarizing plate (90° C. in this case). In the evaluation below, the thermal change due to the heating was light leakage observed through the crossed nicols, which suggests the occurrence of depolarization due to the heating.

O: There was no thermal change due to the heating.
X: There was a thermal change due to the heating.

TABLE 2

| | Thermal Change |
|---|---|
| Example 1 | ∘ |
| Reference Example 1 | x |
| Example 2 | ∘ |
| Reference Example 2 | x |
| Example 3 | ∘ |
| Reference Example 3 | x |
| Example 4 | ∘ |
| Reference Example 4 | x |
| Example 5 | ∘ |
| Reference Example 5 | x |

In Examples, the minute domains, which are cured, maintain anisotropy even after heated. In Reference Examples, however, the minute domains, which are not cured, are made isotropic by heating so that incident polarized light is not depolarized and thus is observed as black.

As a polarizer having a similar structure as a structure of a polarizer of this invention, a polarizer in which a mixed phase of a liquid crystalline birefringent material and an dichroic absorbing material is dispersed in a resin matrix is disclosed in Japanese Patent Laid-Open No. 2002-207118, whose effect is similar as that of this invention. However, as compared with a case where an dichroic absorbing material exists in dispersed phase as in Japanese Patent Laid-Open No. 2002-207118, since in a case where an dichroic absorbing material exists in a matrix layer as in this invention a longer optical path length may be realized by which a scattered polarized light passes absorption layer, more scattered light may be absorbed. Therefore, this invention may demonstrate much higher effect of improvement in light polarizing performance. This invention may be realized with simple manufacturing process.

Although an optical system to which a dichroic dye is added to either of continuous phase or dispersed phase is disclosed in Japanese Patent Laid-Open No. 2000-506990, this invention has large special feature in a point of using not dichroic dye but iodine. The following advantages are realized when using not dichroic dye but iodine. (1) Absorption dichroism demonstrated with iodine is higher than by dichroic dye. Therefore, polarized light characteristics will also become higher if iodine is used for a polarizer obtained. (2) Iodine does not show absorption dichroism, before being added in a continuous phase (matrix phase), and after being dispersed in a matrix, an iodine based light absorbing material showing dichroism is formed by stretching. This point is different from a dichroic dye having dichroism before being added in a continuous phase. That is, iodine exists as iodine itself, when dispersed in a matrix. In this case, in general, iodine has a far effective diffusibility in a matrix compared with a dichroic dye. As a result, iodine based light absorbing material is dispersed to all corners of a film more excellently than dichroic dye. Therefore, an effect of increasing optical path length by scattering anisotropy can be utilized for maximum, which increases polarized light function.

A background of invention given in Japanese Patent Laid-Open No. 2000-506990 describes that optical property of a stretched film in which liquid droplets of a liquid crystal are arranged in a polymer matrix is indicated by Aphonin et al. However, Aphonin et al. has mentioned an optical film comprising a matrix phase and a dispersed phase (liquid crystal component), without using a dichroic dye, and since a liquid crystal component is not a liquid crystal polymer or a polymerized liquid crystal monomer, a liquid crystal component in the film concerned has a sensitive birefringence typically depending on temperatures. On the other hand, this invention provides a polarizer comprising a film having a structure where minute domains are dispersed in a matrix formed of a optically-transparent resin including an iodine based light absorbing material, furthermore, in a liquid crystalline material of this invention, in the case of a liquid crystal polymer, after it is orientated in a liquid crystal temperature range, cooled to room temperatures and thus orientation is fixed, in the case of a liquid crystal monomer, similarly, after orientation, the orientation is fixed by ultraviolet curing etc., birefringence of minute domains formed by a liquid crystalline material does not change by the change of temperatures.

### INDUSTRIAL APPLICABILITY

The polarizer, polarizing plate and laminated optical film obtained by the production method of the invention are suitable for use in image displays such as liquid crystal displays, organic EL displays, CRTs, and PDPs.

1. A method for manufacturing a polarizer,
wherein the polarizer comprises a monolayer film that comprises: a matrix made of an optically-transparent resin containing a dichroic absorbing material; and minute domains that are made of an energy ray-curable birefringent material having liquid crystalline properties and are aligned and dispersed in the matrix; and
comprising a process of applying energy rays for fixing the alignment of the birefringent material having liquid crystalline properties.

2. The method for manufacturing the polarizer according to claim 1, wherein the method comprises the processes of:
(1) preparing a mixture solution that includes the optically-transparent resin and the birefringent material having liquid crystalline properties that is dispersed in the resin;
(2) forming the mixture solution of the process (1) into a film;
(3) orienting the film obtained in the process (2);
(4) dispersing the dichroic absorbing material into the optically-transparent resin for forming the matrix; and
(5) applying the energy rays.

3. The method for manufacturing the polarizer according to claim 2, wherein the mixture solution contains a photopolymerization initiator.

4. A polarizer obtained by the method according to claim 1.

5. A polarizer, comprising:
a monolayer film that comprises: a matrix made of an optically-transparent resin containing a dichroic absorbing material; and minute domains that are made of an energy ray-curable birefringent material having liquid crystalline properties and are aligned and dispersed in the matrix; and a photopolymerization initiator.

6. A polarizing plate, comprising:
the polarizer according to claim 4; and
a transparent protective layer provided on at least one side of the polarizer.

7. An optical film, comprising at least one laminated piece of the polarizer according to claim 4.

8. A method for manufacturing a polarizing plate, comprising adhering a transparent protective layer through an adhesive to the polarizer:
wherein the polarizer comprises a monolayer film that comprises: a matrix made of an optically-transparent resin containing a dichroic absorbing material; and minute domains that are made of an energy ray-curable birefringent material having liquid crystalline properties and are aligned and dispersed in the matrix; and
comprising a process of applying energy rays for fixing the alignment of the birefringent material having liquid crystalline properties after the adhering.

9. A polarizing plate obtained by the method according to claim 8.

10. An optical film, comprising at least one laminated piece of the polarizing plate according to claim 9.

11. A method for manufacturing a laminated optical film, comprising: adhering an optical film through an adhesive or a pressure-sensitive adhesive to a polarizer or a polarizing plate comprising a polarizer and a transparent protective layer provided on at least one side of the polarizer;
wherein the polarizer comprises a monolayer film that comprises: a matrix made of an optically-transparent resin containing a dichroic absorbing material; and minute domains that are made of an energy ray-curable birefringent material having liquid crystalline properties and are aligned and dispersed in the matrix;
comprising a process of applying energy rays for fixing the alignment of the birefringent material having liquid crystalline properties after the adhering.

12. A laminated optical film obtained by the method according to claim 11.

13. An image display, comprising the polarizer according to claim 4.

14. A polarizing plate, comprising: the polarizer according to claim 5.

15. An optical film, comprising at least one laminated piece of the polarizer according to claim 5.

16. An image display, comprising the polarizer according to claim 4.

17. An image display, comprising the polarizer according to claim 5.

18. An image display, comprising the polarizing plate according to claim 9.

19. An image display, comprising the optical film according to claim 12.
